(19) United States
(12) Patent Application Publication
(10) Pub. No.: US 2006/0282250 A1
(43) Pub. Date: Dec. 14, 2006

(54) Logic simulation method and system

(75) Inventor: Genichiro Matsuda, Osaka (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/439,224

(22) Filed: May 24, 2006

(30) Foreign Application Priority Data
May 27, 2005 (JP) 2005-156019

(51) Int. Cl. G06F 17/50

(52) U.S. Cl. 703/14

(57) ABSTRACT

Correlation between a first node included in a high-level circuit and a second node included in a low-level circuit are determined. The high-level circuit and the low-level circuit are obtained by describing a single logic circuit at two different levels. In logic simulation, the expected value of the first node is “1” and the expected value of the second node is an indefinite value, from which the occurrence of an expected-value error node is detected. In this case, “0” and “1” are assigned to another indefinite-value node that causes the indefinite value of the second node so as to perform logic simulation for each value. And after confirming that the second node has the same value “1” in each logic simulation, the value of the expected-value error node is rewritten with the fixed value “1”. Then, the expected value error between the first and second nodes is corrected, such that the logic simulation can be continuously executed.

### BACKGROUND OF THE INVENTION

The present invention relates to logic simulation methods and systems for verifying operation of logic circuits.

In conventional logic simulation, if an indefinite value in logic operation occurs at a node during execution of the logic simulation, the logic elements into which the logical value of that node is input also output the indefinite value. The logic simulation thus cannot be continued and has to be stopped. And it is also required to change the input signal pattern and then re-execute the logic simulation, which results in increase in the logic simulation execution time.

In a conventional technique, therefore, if occurrence of an indefinite value is detected during execution of logic simulation, the indefinite-value-detected node is fixed at a logical value “0” (L:Low) or a logical value “1” (H:High) so that the logic simulation result agrees with an expected value (see Japanese Laid-Open Publication No. 5-46696).

Nevertheless, in a high-level circuit and a low-level circuit, obtained by describing a single logic circuit at two different levels, a problem sometimes occurs in that these high- and low-level circuits operate differently due to the influence of an indefinite value in spite of the fact that they have the same function. For instance, the node in the low-level circuit that corresponds to a node having a fixed value “1” in the high-level circuit may have an indefinite value.

### SUMMARY OF THE INVENTION

It is therefore an object of the present invention to mitigate adverse effects of an indefinite value in logic simulation.

In order to achieve the object, a first inventive logic simulation method includes: in logic simulation of a logic circuit, the step (1) of detecting a focus node having an indefinite value in a storage element or an output terminal in the logic circuit; the step (2) of detecting, in a cone portion which includes circuit elements determining logic of the focus node and whose inputs are storage elements or input terminals in the logic circuit, a node group composed of all nodes existing in the cone portion; the step (3) of assigning values of all combinations of 0 and 1 to nodes belonging to the node group and having the indefinite value, and performing logic simulation; and the step (4) of, if the focus node has the same value for the values of all combinations, setting that same value as an expected value of the focus node in place of the indefinite value of the focus node.

Also, a second inventive logic simulation method includes: in logic simulation of a logic circuit, the step (1) of determining correlation between a storage element or an output terminal included in a high-level circuit and a storage element or an output terminal included a low-level circuit, the high- and low-level circuits being obtained by describing the logic circuit at two different levels; the step (2) of detecting a focus node at which an expected value of the storage element or the output terminal in the high-level circuit is a fixed value and a focus node at which an expected value of the storage element or the output terminal in the low-level circuit that has been correlated with the storage element or the output terminal in the high-level circuit in the step 1 is the indefinite value; the step (3) of detecting, in a cone portion which includes circuit elements determining logic of the focus node in the low-level circuit and whose inputs are storage elements or input terminals in the low-level circuit, a node group composed of all nodes existing in the cone portion; the step (4) of assigning values of all combinations of 0 and 1 to nodes belonging to the node group and having the indefinite value, and performing logic simulation; and the step (5) of, if the focus node in the low-level circuit has the same value for the values of all combinations, setting that same value as the expected value of the focus node in the low-level circuit in place of the indefinite value of that focus node.

According to the present invention, adverse effects of an indefinite value in logic simulation are mitigated, continuous execution of the logic simulation is ensured, and the simulation time is shortened.

Furthermore, it is possible to avoid an expected value error caused by an indefinite value between a high-level circuit and a low-level circuit, whereby the shortening of the logic simulation time and the high quality low-level circuit are realized.

### BRIEF DESCRIPTION OF THE DRAWINGS

FIG. 1 is a block diagram illustrating an exemplary hardware configuration of a logic simulation system according to the present invention.

FIGS. 2A, 2B, 2C and 2D are truth tables for an AND element, an OR element, an Ex-OR element, and a MUX element, respectively.

FIG. 3 is a schematic view of a first exemplary circuit to which the present invention is applicable.

FIG. 4 is a flow chart for a logic simulation method according to a first embodiment of the present invention.

FIG. 5 is a flow chart showing a modified example of FIG. 4.

FIG. 6 is a flow chart showing another modified example of FIG. 4.

FIG. 7 is a schematic view of a second exemplary circuit to which the present invention is applicable.

FIG. 8 shows RTL description in a high-level circuit shown in FIG. 7.

FIG. 9 is a flow chart for a logic simulation method according to a second embodiment of the present invention.

FIG. 10 is a flow chart showing a modified example of FIG. 9.

FIG. 11 is a flow chart showing another modified example of FIG. 9.

### DETAILED DESCRIPTION OF THE INVENTION

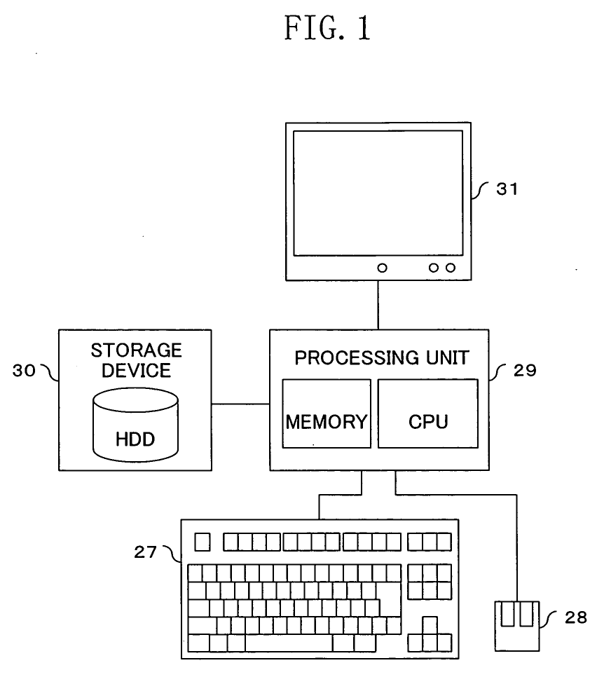

FIG. 1 is a block diagram illustrating an exemplary hardware configuration of a logic simulation system according to the present invention. In FIG. 1, the reference numeral 27 denotes a keyboard on which letter keys, number keys, function keys and the like are provided and which is used for various key inputs. The reference numeral 28 represents a mouse, which is used to input position data indicated by the mouse cursor. By these input devices such as the keyboard 27 and the mouse 28, instructions and the like are input which include an instruction for preparation of a test pattern for performing logic simulation of an input logic circuit, an instruction for execution of the logic simulation, and an instruction for comparison and verification of the logic simulation result. The reference numeral 29 indicates a processing unit, which is a microcomputer including a CPU, memories (ROM and RAM) and the like. The processing unit 29 controls the entire system, while carrying out processing, such as logical operation processing for performing logic simulation of a logic circuit, processing for storing the logic simulation result in a storage device 30 in a file format, processing for reading the logic simulation result stored in the storage device 30 into an internal memory, processing for comparing and verifying the logic simulation result, and processing for displaying the logic simulation result, the comparison and verification result, and the like on a display device 31. The storage device 30 is a HDD (hard disk drive) or the like and stores therein logic circuits, results of logic simulation of the logic circuits, and the like. The display device 31 is a display unit such as a CRT or an LCD, and displays the logic simulation result, the comparison and verification result, various messages, and the like.

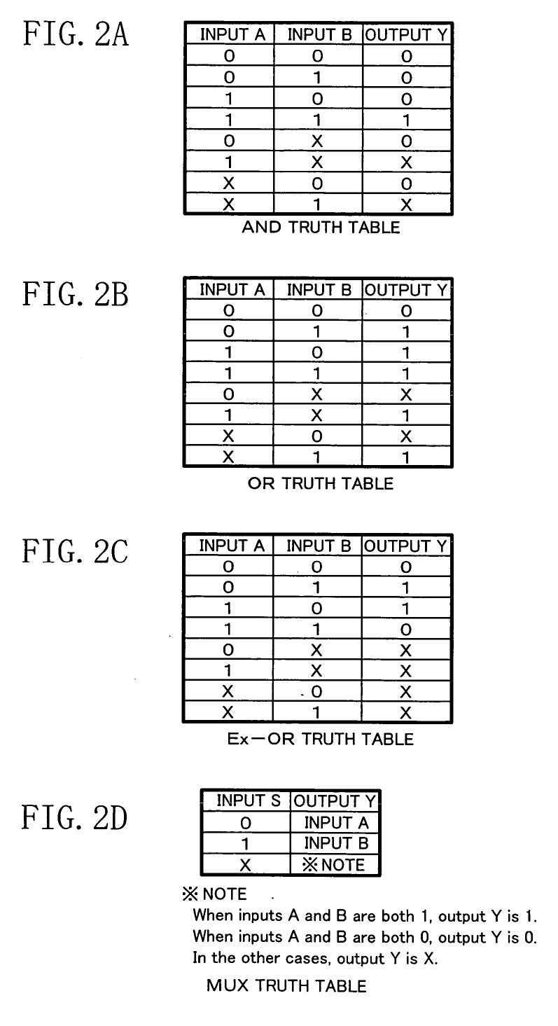

Logic simulation is executed according to truth tables for logical product (AND), logical sum (OR), exclusive OR (Ex-OR), multiplexer (MUX), and the like. FIGS. 2A, 2B, 2C and 2D show truth tables for an AND element, an OR element, an Ex-OR element, and a MUX element, respectively. In these figures, the mark “X” indicates an indefinite value.

### First Embodiment

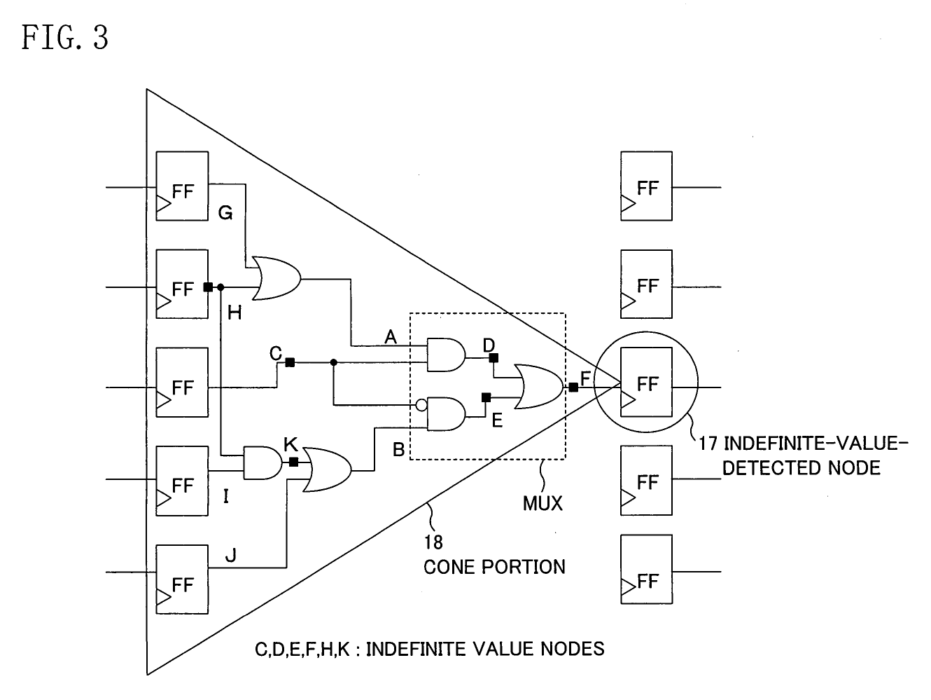

FIG. 3 is a schematic view of a first exemplary circuit to which the present invention is applicable. In FIG. 3, the reference numeral 17 denotes a node (a focus node) at which an indefinite value (X) has been detected in a step during logic simulation. The reference numeral 18 represents a cone portion which determines the logic of the indefinite-value-detected node 17. In the cone portion 18, nodes C, D, E, F, H, and K have the indefinite value (X), and nodes A and B have a fixed value “1”.

In the MUX shown in FIG. 2D, even if the indefinite value (X) is input to an S terminal, the value at an output terminal Y is “1” so long as “1” has been input to input terminals A and B. In the MUX circuit shown in FIG. 3, however, when the indefinite value (X) is input to the node C, the value at the node F is the indefinite value (X) even if “1” has been input to the nodes A and B, although the MUX circuit, composed of an AND, an OR and an inverter, has the same function as the MUX shown in FIG. 2D. In this manner, if the indefinite value (X) occurs in one node, the logic element to which the logical value of that node is input also outputs the indefinite value (X), which results in runaway of the logic simulation, such that the logic simulation cannot be continued.

Therefore, in the first embodiment of the present invention, “0” and “1” are assigned to the indefinite-value node C that causes the indefinite value (X) at the node F in FIG. 3 so as to perform logic simulation for each value. And after confirming that the node F has the same value “1” in each logic simulation, the value at the indefinite-value-detected node 17 is rewritten with the fixed value “1”.

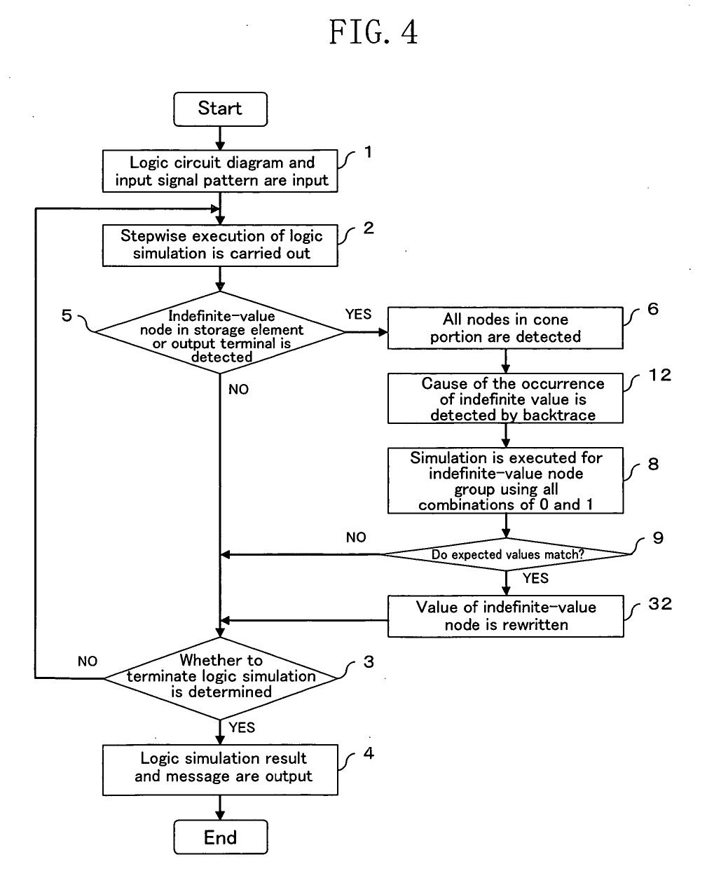

FIG. 4 is a flow chart for a logic simulation method for enabling the above-described processing in accordance with the first embodiment of the present invention. In FIG. 4, the reference numeral 1 denotes a step in which the logic circuit diagram and an input signal pattern are input, and the reference numeral 2 denotes a step in which stepwise execution of logic simulation is carried out according to the information input in the step 1. The stepwise execution herein means “performing one cycle of logic simulation”. The reference numeral 5 represents a step in which a node group PS1 is detected. The node group PS1 is composed of nodes in storage elements (FF) or output terminals at which the indefinite value (X) has occurred. The reference numeral 6 indicates a step in which a node group PH1 is detected. The node group PH1 is composed of nodes that determine the logic of the nodes belonging to the indefinite-value-detected node group PS1 and exist in or before the storage elements or the input terminals functioning as the inputs of the cone portion 18. The reference numeral 12 represents a step in which, from the node group PH1 detected in the step 6, a group of nodes that cause the occurrence of the indefinite value (X) is detected by backtrace. The reference numeral 8 indicates a step in which the values of all combinations of 0 and 1 are assigned to the node group detected in the step 12 so as to perform logic simulation. The reference numeral 9 denotes a step in which it is determined whether the nodes belonging to the indefinite-value-detected node group PS1 have the same value for the values of all combinations. The reference numeral 32 indicates a step in which the value of the indefinite-value-detected node 17 is rewritten with a matching expected value. The reference numeral 3 represents a step in which it is determined whether all events have been completed and the logic simulation is terminated. The reference numeral 4 represents a step in which the logic simulation result and a message are output.

First, the logic circuit diagram shown in FIG. 3 and a signal pattern to be input into the logic circuit diagram are input (in the step 1). Next, stepwise execution of logic simulation is performed using the input logic circuit diagram and the input signal pattern to be input into the logic circuit diagram (in the step 2). When the stepwise execution is complete, the procedure goes to the step 5 in which it is detected whether an indefinite value (X) has occurred in the storage elements or the output terminals. In the step 5, if the indefinite value (X) has not been detected, the procedure goes to the step 3 in which whether all events have been completed is determined. If all events have not been completed, the procedure returns to the step 2 in which the stepwise execution of the logic simulation is performed again (in the step 2). In the case where the indefinite value (X) has not been detected in the step 5, the following steps are repeated in the order 2, 5, 3, and 2, and at the point in time when all events have been completed, the procedure goes from the step 3 to the step 4, in which the logic simulation result and a message are output, and the logic simulation is terminated.

In the step 5 during a repeated cycle, if the indefinite value (X) is detected at the node 17 as shown in FIG. 3, the procedure goes to the step 6 in which the group PH1 (of the nodes A, B, C, D, E, F, G, H, I, J, and K) in the cone portion 18 that determines the logic of the indefinite-value-detected node 17 is detected. In this step, it is assumed that the nodes C, D, E, F, H and K each have the indefinite value (X) and the nodes A and B each have the fixed value “1” as mentioned above. When the step 6 has been completed and the node group PH1 has been detected, the procedure goes to the step 12 in which, from the node group PH1, a group of nodes that cause the occurrence of the indefinite value (X) at the indefinite-value-detected node 17 is detected by backtrace. The detection, by backtrace, of the group of nodes that cause the occurrence of the indefinite value (X) at the node 17 is performed by repeating a step in which a node having the indefinite value (X) is detected in the input terminals of the logic element that drives a node having the indefinite value (X) and thereby specifying the logic element that causes the occurrence of the indefinite value (X) at the node 17 or the storage elements or the input terminals that are the inputs of the cone portion 18. More specifically, the nodes D and E (having the indefinite value) which are the inputs of the logic element that drives the node F having the indefinite value (X) in FIG. 3 are detected, and from the nodes A, B, and C which are the inputs of the logic elements that drive the nodes D and E, the node C having the indefinite value (X) is specified.

Subsequently, the procedure goes to the step 8 in which the values of all combinations of 0 and 1 are assigned to the node group detected in the step 12 so as to perform logic simulation. To be specific, “0” and “1” are assigned to the node C to perform stepwise execution of logic simulation for each value. In this process, since the nodes A and B have the fixed value “1”, if the node C is “0”, the node D is “0”, the node E is “1” and the node F is “1”. On the other hand, if the node C is “1”, the node D is “1”, the node E is “0”, and the node F is “1” also in this case. Next, the procedure goes to the step 9 in which it is determined whether the nodes belonging to the indefinite-value-detected node group PS1 have the same value for the values of all combinations. In this embodiment, since the node F has the same value “1” for the values of all combinations in the step 8, the procedure goes to the step 32 in which the value of the indefinite-value-detected node 17 is rewritten with the fixed value “1”, and then the procedure goes to the step 3. If it is determined in the step 9 that the node F does not have the same value, the procedure goes to the step 3 without going to the step 32.

By performing the logic simulation in the above-described manner, it is possible to continue the execution of the logic simulation, even if the indefinite value (X) occurs, whereby the logic simulation execution time can be shortened.

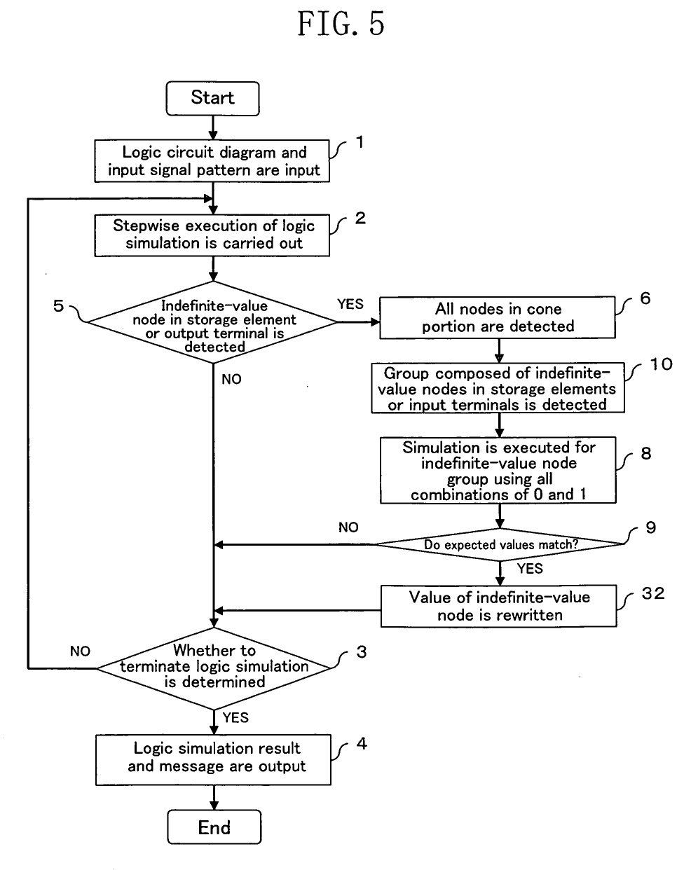

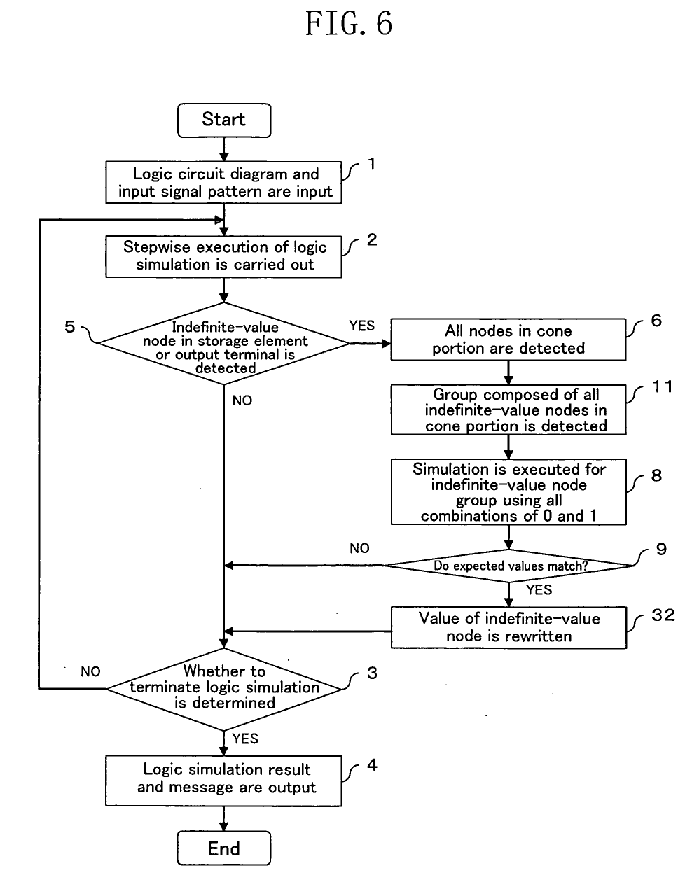

As shown in a step 10 in FIG. 5, of the indefinite-value nodes in the cone portion 18, the nodes to which “0” and “1” are assigned may be limited to those nodes in the storage elements or the input terminals that are the inputs of the cone portion 18. As compared with the step 12 in which the cause of occurrence of the indefinite value is detected by backtrace as described above, the detection algorithm in the step 10 has the advantage of being simple. Alternatively, as shown in a step 11 in FIG. 6, “0” and “1” may be assigned to all indefinite-value nodes in the cone portion 18.

### Second Embodiment

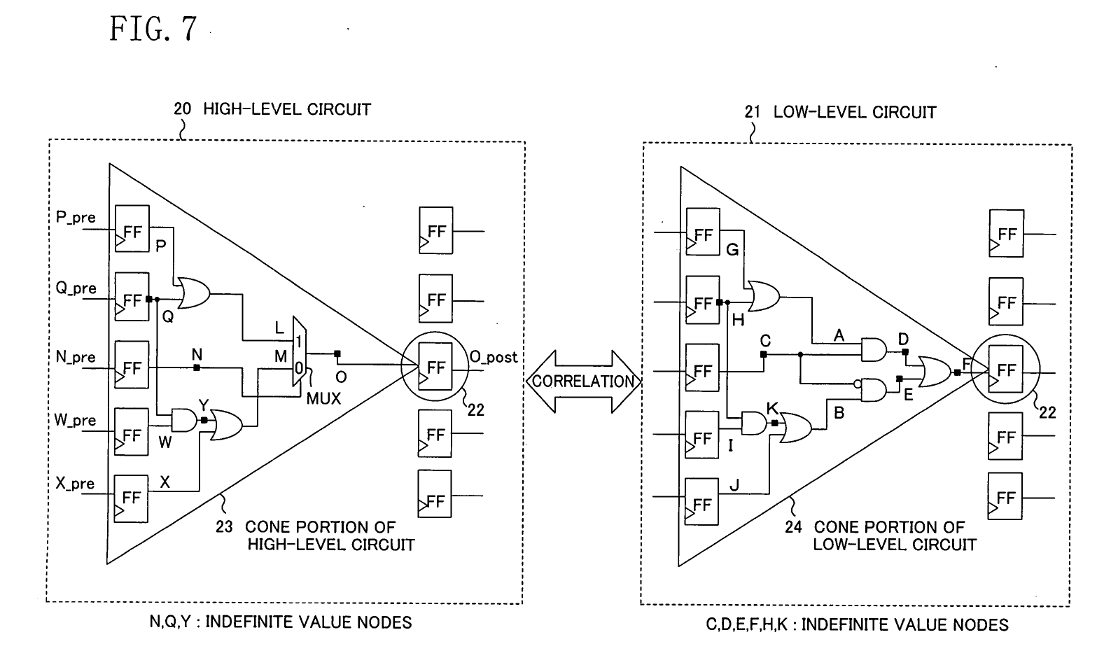

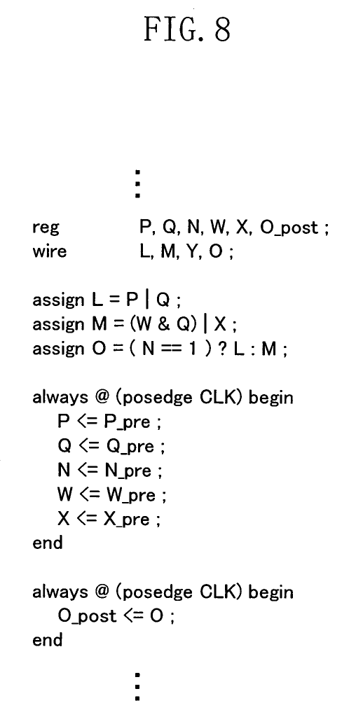

FIG. 7 is a schematic view of a second exemplary circuit to which the present invention is applicable. FIG. 8 shows RTL (Register Transfer Level) description in a high-level circuit 20 shown in FIG. 7. In FIG. 7, the high-level circuit 20 shows in schematic form the RTL description shown in FIG. 8. The reference numeral 21 denotes a low-level circuit (gate-level netlist) obtained by logic synthesis of the high-level circuit 20. In the low-level circuit 21, a MUX in the high-level circuit 20 is replaced with a circuit composed of an AND, an OR, and an inverter such as shown in FIG. 3. The reference numeral 22 denotes expected-value error nodes (focus nodes) occurring in a step during logic simulation, at which the expected value of a storage element or an output terminal in the high-level circuit 20 is a fixed value (0 or 1) and the expected value of the corresponding storage element or output terminal in the low-level circuit 21 is an indefinite value (X). The reference numeral 23 indicates a cone portion of the high-level circuit 20 which determines the logic of the expected-value error node 22. The reference numeral 24 denotes a cone portion of the low-level circuit 21 which determines the logic of the expected-value error node 22. In the cone portion 23 of the high-level circuit, nodes N, Q, and Y have the indefinite value (X) and nodes L, M, and O have a fixed value “1”. In the cone portion 24 of the low-level circuit, nodes C, D, E, F, H, and K have the indefinite value (X) and nodes A and B have the fixed value “1.”

In the high-level circuit 20 and the low-level circuit 21, obtained by describing the single logic circuit at two different levels as described above, a problem arises in that the high- and low-level circuits 20 and 21 operate differently due to the influence of the indefinite value (X) in spite of the fact that they have the same function. To be specific, the problem occurs in that the expected values of the corresponding output terminals differ between the RTL and the netlist. When such an expected value error occurs between the RTL and the netlist, the input pattern must be changed to a different one that will not cause the indefinite value, the MUX circuit in the netlist, composed of the AND, the OR, and the inverter, must be modified into a single logic cell having the function of FIG. 2D, or other steps have to be taken in order to avoid the occurrence of the expected value error. This results in increase in the number of design steps. In addition, a MUX circuit composed of an AND, an OR, and an inverter typically operates at higher speed than a single logic cell having the function of FIG. 2D. Therefore, the modification into a single logic cell having the function of FIG. 2D causes performance deterioration.

In view of this, in the second embodiment of the present invention, “0” and “1” are assigned to the indefinite-value node C that causes the indefinite value (X) at the node F in FIG. 7 to perform logic simulation for each value. And after confirming that the node F has the same value “1” in each logic simulation, the value at the expected-value error node (indefinite-value node) 22 is rewritten with the fixed value “1”. Then, the expected value error occurring between the nodes O and F is corrected.

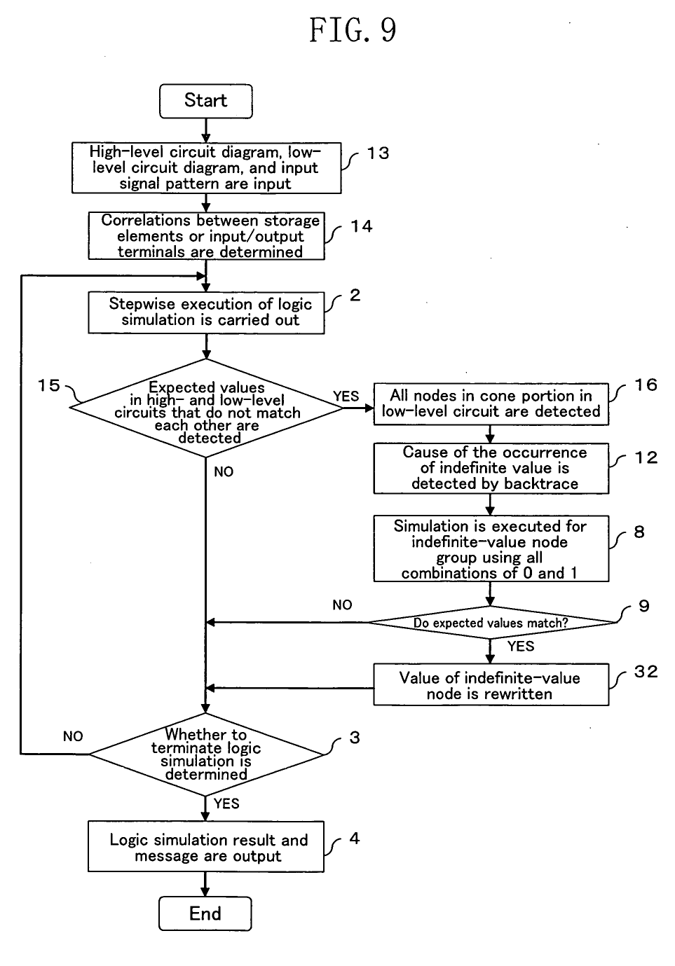

FIG. 9 is a flow chart for a logic simulation method for enabling the above-described processing in accordance with the second embodiment of the present invention. In FIG. 9, the reference numeral 13 denotes a step in which the high-level circuit diagram, the low-level circuit diagram, and an input signal pattern are input, and the reference numeral 14 denotes a step in which correlations between the storage elements or the output terminals included in the high- and low-level circuits 20 and 21 input in the step 13 are determined. The reference numeral 15 indicates a step in which a node group PS2 is detected. At the nodes of the node group PS2, the storage elements or the output terminals in the high-level circuit 20 and the storage elements or the output terminals in the low-level circuit 21 that have been correlated with each other in the step 14 do not have the matching expected values. The reference numeral 16 represents a step in which a node group PH2 is detected. The nodes of the node group PH2 determine the logic of the nodes belonging to the node group PS2 and exist in or before the storage elements or the input terminals that are the inputs of the cone portion 24 of the low-level circuit. The reference numeral 12 represents a step in which, from the node group PH2 detected in the step 16, a group of nodes that cause the occurrence of the indefinite value (X) is detected by backtrace. The other steps 2, 3, 4, 8, 9, and 32 are the same as those shown in FIG. 4 and descriptions thereof will be thus omitted.

First, the high-level circuit diagram and the low-level circuit diagram shown in FIG. 7 and a signal pattern are input (in the step 13). Next, correlations between the storage elements or the output terminals in the input high- and low-level circuit diagrams are determined (in the step 14). Subsequently, stepwise execution of logic simulation is performed in each of the high- and low-level circuits 20 and 21 by using the input high- and low-level circuit diagrams and the input input signal pattern (in the step 2). Upon the completion of the stepwise execution, the procedure goes to the step 15 of detecting, as the expected-value error nodes 22, nodes at which the expected value of the storage element or the output terminal in the high-level circuit 20 does not agree with the expected value of the corresponding storage element or output terminal in the low-level circuit 21. In the step 15, if no expected-value error node is detected, the procedure goes to the step 3 in which it is determined whether all events have been completed. If all events have not been completed, the procedure returns to the step 2 in which the stepwise execution of the logic simulation is performed again (in the step 2). In the case where no expected-value error node is detected in the step 15, the following steps are repeated in the order 2, 15, 3, and 2, and at the point in time when all events have been completed, the procedure goes from the step 3 to the step 4, in which the logic simulation result and a message are output, and the logic simulation is completed.

It is assumed that in the step 15 during a repeated cycle, the expected-value error nodes 22 have been detected as shown in FIG. 7. And it is assumed that at this time, the nodes N, Q, and Y in the high-level circuit 20 and the nodes C, D, E, F, H, and K in the low-level circuit 21 have the indefinite value (X) and that the nodes L, M, and O in the high-level circuit 20 and the nodes A and B in the low-level circuit 21 have the fixed value “1” as described above. As can be seen from FIG. 2D, in the MUX in the high-level circuit 20, even if the indefinite value (X) is input to the node N, the node O has the fixed value “1” because “1” is input into the nodes L and M.

If the indefinite value (X) is detected at the expected-value error node 22 in the low-level circuit 21, the procedure goes to the step 16 in which the node group PH2 (of the nodes A, B, C, D, E, F, G, H, I, J, and K) in the cone portion 24 that determines the logic of the expected-value error node 22 is detected. When the step 16 has been completed and the node group PH2 has been detected, the procedure goes to the step 12 in which, from the node group PH2, a group of nodes that cause the occurrence of the indefinite value (X) at the expected-value error node 22 is detected by backtrace. The detection method by backtrace in this embodiment is the same as that of the first embodiment. To be specific, the nodes D and E (having the indefinite value) that are the inputs of the logic element that drives the node F having the indefinite value (X) shown in FIG. 7 are detected, and from the nodes A, B, and C that are the inputs of the logic elements that drive these nodes D and E, the node C having the indefinite value (X) is specified.

Subsequently, the procedure goes to the step 8 in which the values of all combinations of 0 and 1 are assigned to the node group detected in the step 12 to perform logic simulation. More specifically, “0” and “1” are assigned to the node C to perform stepwise execution of logic simulation for each value. In this process, since the nodes A and B have the fixed value “1”, if the node C is “0”, the node D is “0”, the node E is “1” and the node F is “1”. On the other hand, if the node C is “1”, the node D is “1”, the node E is “0”, and the node F is “1” also in this case. Next, the procedure goes to the step 9 in which it is determined whether the nodes belonging to the expected-value error node group PS2 have the same value for the values of all combinations. In this embodiment, since the node F has the same value “1” for the values of all combinations in the step 8, the procedure goes to the step 32 in which the value of the expected-value error node (indefinite-value node) 22 in the low-level circuit 21 is rewritten with the fixed value “1”, and then the procedure goes to the step 3. If it is determined in the step 9 that the node F does not have the same value, the procedure goes to the step 3 without going to the step 32.

It should be noted that the correction of the expected value error at the node 22 by the rewrite performed in the step 32 may be confirmed. That is, it may be confirmed that the fixed expected value of the focus node 22 in the high-level circuit 20 agrees with the expected value of the focus node 22 in the low-level circuit 21 that has been rewritten in the step 32. In the example shown in FIG. 7, those expected values are both “1” and agree with each other, which indicates that the error has been corrected.

By performing the logic simulation in the above-described manner, the execution of the logic simulation can be continued even if the indefinite value (X) occurs, while it becomes possible to avoid the expected value error between the high-level circuit 20 and the low-level circuit 21, whereby the logic simulation execution time can be reduced.

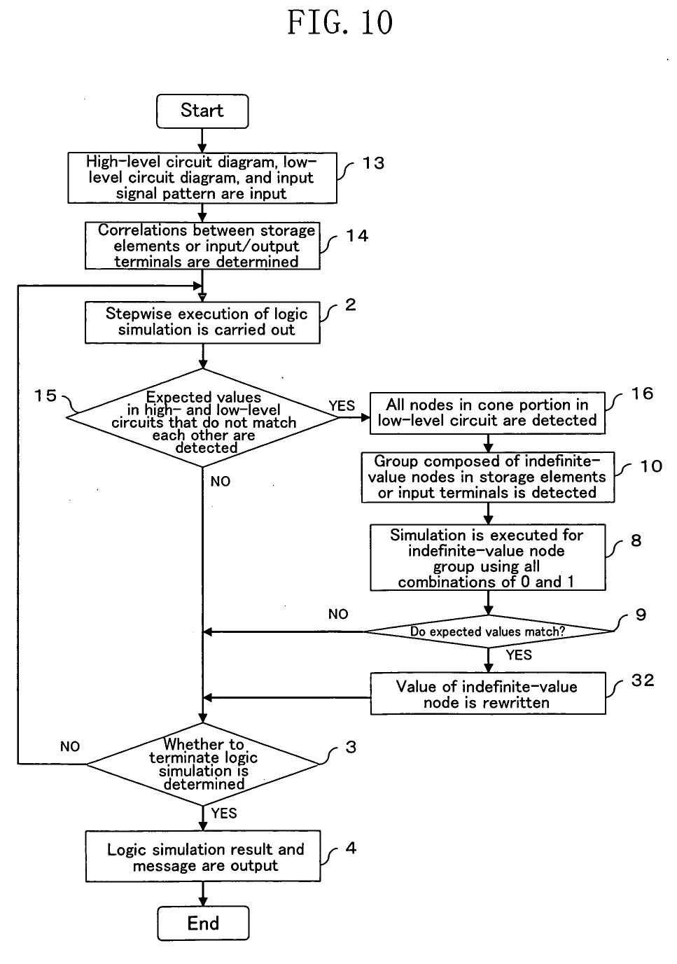

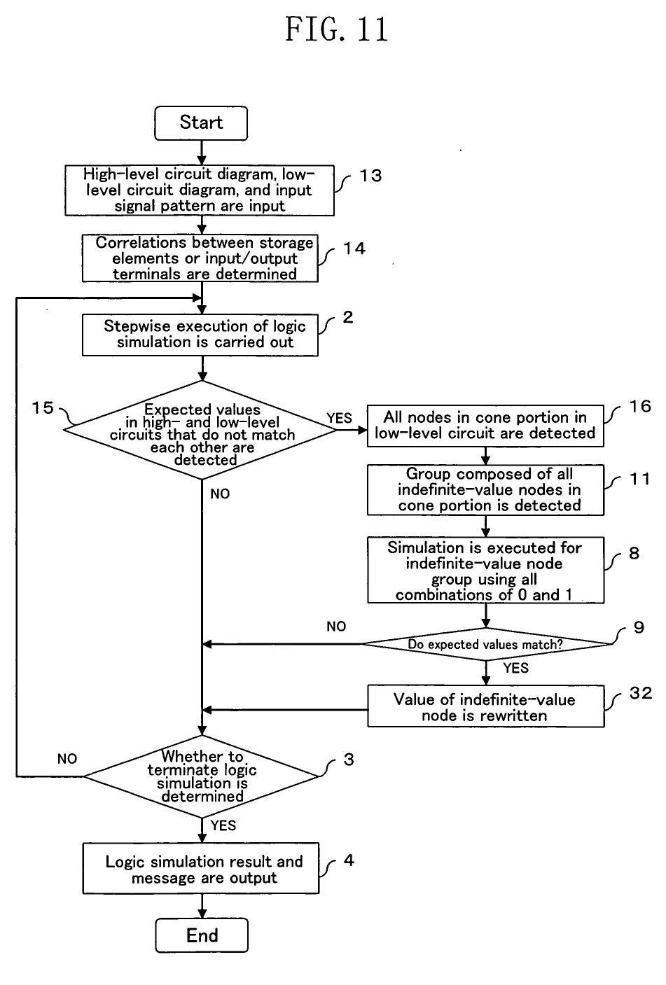

As shown in the step 10 in FIG. 10, of the indefinite-value nodes in the cone portion 24 in the low-level circuit, the nodes to which “0” and “1” are assigned may be limited to those nodes in the storage elements or the input terminals that are the inputs of the cone portion 24. As compared with the step 12 in which the cause of occurrence of the indefinite value is detected by backtrace as described above, the detection algorithm in the step 10 has the advantage of being simple. Alternatively, as shown in the step 11 in FIG. 11, “0” and “1” may be assigned to all indefinite-value nodes in the cone portion 24 in the low-level circuit.

As described above, the logic simulation methods and systems according to the present invention have the effect that the need for input pattern change and low-level-circuit modification is eliminated, and are thus applicable, e.g., to techniques for realizing short-time design of, and performance increase in, semiconductor devices.

What is claimed is:

1. A logic simulation method comprising:
in logic simulation of a logic circuit,
the step (1) of detecting a focus node having an indefinite value in a storage element or an output terminal in the logic circuit;
the step (2) of detecting, in a cone portion which includes circuit elements determining logic of the focus node and whose inputs are storage elements or input terminals in the logic circuit, a node group composed of all nodes existing in the cone portion;
the step (3) of assigning values of all combinations of 0 and 1 to nodes belonging to the node group and having the indefinite value, and performing logic simulation; and
the step (4) of, if the focus node has the same value for the values of all combinations, setting that same value as an expected value of the focus node in place of the indefinite value of the focus node.

2. The method of claim 1, wherein the step (3) includes the step of specifying, by backtrace, a node that causes the occurrence of the indefinite value at the focus node from the nodes belonging to the node group and having the indefinite value, and assigning the values of all combinations of 0 and 1 only to the specified node.

3. The method of claim 1, wherein the step (3) includes the step of assigning the values of all combinations of 0 and 1 only to one or more of the nodes belonging to the node group and having the indefinite value, the one or more nodes existing in the storage elements or the input terminals that are the inputs of the cone portion.

4. The method of claim 1, wherein the step (3) includes the step of assigning the values of all combinations of 0 and 1 to all of the nodes belonging to the node group and having the indefinite value.

5. A logic simulation method comprising:
in logic simulation of a logic circuit, the step (1) of determining correlation between a storage element or an output terminal included in a high-level circuit and a storage element or an output terminal included a low-level circuit, the high- and low-level circuits being obtained by describing the logic circuit at two different levels;
the step (2) of detecting a focus node at which an expected value of the storage element or the output terminal in the high-level circuit is a fixed value and a focus node at which an expected value of the storage element or the output terminal in the low-level circuit that has been correlated with the storage element or the output terminal in the high-level circuit in the step 1 is the indefinite value;
the step (3) of detecting, in a cone portion which includes circuit elements determining logic of the focus node in the low-level circuit and whose inputs are storage elements or input terminals in the low-level circuit, a node group composed of all nodes existing in the cone portion;
the step (4) of assigning values of all combinations of 0 and 1 to nodes belonging to the node group and having the indefinite value, and performing logic simulation; and
the step (5) of, if the focus node in the low-level circuit has the same value for the values of all combinations, setting that same value as the expected value of the focus node in the low-level circuit in place of the indefinite value of that focus node.

6. The method of claim 5, wherein the step (4) includes the step of specifying, by backtrace, a node that causes the occurrence of the indefinite value at the focus node in the low-level circuit from the nodes belonging to the node group and having the indefinite value, and assigning the values of all combinations of 0 and I only to the specified node.

7. The method of claim 5, wherein the step (4) includes the step of assigning the values of all combinations of 0 and 1 only to one or more of the nodes belonging to the node group and having the indefinite value, the one or more nodes existing in the storage elements or the input terminals that are the inputs of the cone portion in the low-level circuit.

8. The method of claim 5, wherein the step (4) includes the step of assigning the values of all combinations of 0 and 1 to all of the nodes belonging to the node group and having the indefinite value.

9. The method of claim 5, further comprising the step (6) of confirming that the fixed expected value of the focus node in the high-level circuit agrees with the expected value of the focus node in the low-level circuit that has been newly written in the step (5).

10. A system for performing logic simulation of a logic circuit, comprising:
first means for detecting a focus node having an indefinite value in a storage element or an output terminal in the logic circuit;
second means for detecting, in a cone portion which includes circuit elements determining logic of the focus node and whose inputs are storage elements or input terminals in the logic circuit, a node group composed of all nodes existing in the cone portion;
third means for assigning values of all combinations of 0 and 1 to nodes belonging to the node group and having the indefinite value, and performing logic simulation; and
fourth means for, if the focus node has the same value for the values of all combinations, setting that same value as an expected value of the focus node in place of the indefinite value of the focus node.

11. A system for performing logic simulation of a logic circuit, comprising:
first means for determining correlation between a storage element or an output terminal included in a high-level circuit and a storage element or an output terminal included a low-level circuit, the high- and low-level circuits being obtained by describing the logic circuit at two different levels;
second means for detecting a focus node at which an expected value of the storage element or the output terminal in the high-level circuit is a fixed value and a focus node at which an expected value of the storage element or the output terminal in the low-level circuit that has been correlated with the storage element or the output terminal in the high-level circuit by the first means is the indefinite value;
third means for detecting, in a cone portion which includes circuit elements determining logic of the focus node in the low-level circuit and whose inputs are storage elements or input terminals in the low-level circuit, a node group composed of all nodes existing in the cone portion;
fourth means for assigning values of all combinations of 0 and 1 to nodes belonging to the node group and having the indefinite value, and performing logic simulation; and
fifth means for, if the focus node in the low-level circuit has the same value for the values of all combinations, setting that same value as the expected value of the focus node in the low-level circuit in place of the indefinite value of that focus node.
